(19) United States
(12) Patent Application Publication
(10) Pub. No.: US 2019/0166098 A1
(43) Pub. Date: May 30, 2019

(54) Methods and Systems for Protecting Computer Networks by Modulating Defenses

(71) Applicant: PacketViper, LLC, Pittsburgh, PA (US)

(72) Inventor: Francesco Trama, Pittsburgh, PA (US)

(73) Assignee: PacketViper, LLC, Pittsburgh, PA (US)

(21) Appl. No.: 15/825,095

(22) Filed: Nov. 28, 2017

(51) Int. Cl. H04L 29/06

(52) U.S. Cl. CPC H04L 63/0263; H04L 63/1425; H04L 63/0272; H04L 63/1416; H04L 63/1433; H04L 63/0236

(57) ABSTRACT

A network security system protects a computer network by evaluating all incoming data packets with one or more triggers to determine whether the incoming data packets are suspect data packets or acceptable data packets. The system changes the triggers and sensors that incoming packets encounter according to a programmable schedule, which makes attackers confused and uncertain about the network. When suspect data packets are encountered, the system performs one or more protective actions with respect to the suspect data packet. Some of these actions include logging, allowing, delaying, blocking, redirecting, and trapping the suspect data packets.

### FIELD OF INVENTION

The invention relates to systems and methods for reducing traffic volume, providing forensics, and protecting a computer network.

### BACKGROUND OF INVENTION

Today's global computer networks are protected against threats by security products, such as firewalls, that create a secure perimeter for the protected network environment. It is still necessary, however, to provide external access to network ports in order to provide users with services such as VPN, FTP, or VOIP, for example. Unfortunately, this creates a security vulnerability because these ports are, by definition, access points to the network and they can potentially be exploited by unauthorized third parties.

In networks protected by today's firewalls, the public access points are typically static and change infrequently. While keeping the same public ports open eases administration, it can negatively impact security. The Mirai malware, for example, most notable for infections and DDoS attacks in 2016, was able to infect a massive number of IoT enabled devices as well as complex networks simply by scanning networks for public ports on those internet-connected devices and attempting to gain access using well-known default username and password combinations. Another tool employed by attackers is the network mapper security scanner (Nmap) that scans networks for, among other things, responding network ports. Once this information is gleaned, an attack can be planned.

To buttress network security, some firewalls can be configured so that they provide a segmented network area on the public perimeter, separated from sensitive network resources, where public service access can take place. Additional known safety measures include inspection technology that checks traffic for anomalies that may threaten the services or the network being protected. In some cases, the services themselves may even have their own protections to fend off attacks or threats.

As networks become more complex, network perimeters must as well. Complexity, however, has an unintended consequence called network blindness. Complicated rule sets, logging, and alerting all combine to create this situation and the continuous stream of traffic requires network administrators to adjust firewall rule sets on a periodic basis in order to stay ahead of attackers.

Security inspections at the perimeter prevent known attackers from gaining access to the network, but the lists of these known attackers must be constantly updated and, thus, these security inspections often only look for known attack vectors. As a result, the perimeter may miss a vector if it's previously unreported and the protected system may become infected. Alternatively, the security product may employ threat signatures, behavior algorithms, or predictive analysis, but because these are all based on historical threats, the alerts generated could be broader than necessary. Erring on the side of caution results in excessive alerting about a potential threat to the users of the protected network, which leads to the discounting of new alerts that may actually represent a risk to the network.

To further reduce risk, security products may employ IP address blacklists that block traffic from IP addresses that have been determined or reported to be harmful in some way, but this has limited utility because IP addresses can become stale very quickly. Additionally, new, otherwise upstanding networks can become infected, making it difficult to recognize traffic from those systems as being problematic.

FIG. 1 illustrates a server 20, that may be part of a LAN setup, protected by a conventional firewall 22. A port 24 in the firewall 22 provides access to services such as a virtual private network (VPN) 26 server, a mail server 28, FTP, VOIP, SSH or a web server 30. The port 24 can be a TCP 443, UDP 500, or some other network port that the server 20 designates. The port 24 is likely a static network port that is exposed on the security perimeter. Other known embodiments of server 20 expose the port 24 (or a specific set of network ports) unabated on the internet 200. Still other embodiments display the secure network port 24 (or ports) when they are required to be enabled for secure communication. Some firewalls may actively evaluate traffic from an attacker 42 while others may shunt all or only suspect network traffic to a segregated area 40 for evaluation or testing before permitting it to proceed to sensitive servers 26, 28, or 30. The port 24 can then be easily identified and exposed to attackers that can explore for vulnerabilities using tools such as NMAP, which can come from any number of different sources and can be built to only scan portions of the network IP destinations and ports to avoid drawing attention to their activities.

In one common form of attack, attackers will build bot nets for specific purposes, which reduce the chance of discovery and improve the overall harvesting result. Scanning bot networks, for example, have the sole purpose of continuously scanning the internet for responses from networks, which indicate services ports that may be unsecured. Once these ports are discovered, probe bots are dispatched to get more information about the newly discovered services such as: service capability, type, version, or known vulnerabilities. This information is then passed on to flood bots that are used to incapacitate, annoy, or distract the victim network from its ultimate goal. All of these bot networks are used together for the best chance of success. Because the attacker's resources are discovered fairly regularly, they are continuously replenishing their ranks, which makes the bot networks fluid and difficult to block based on their location.

What is needed is a method of using existing security tools in a way that reduces overall traffic through the firewall, deceives attackers, gathers intelligence about such attackers, and actively filters threat sources before they can access the protected network.

### SUMMARY OF INVENTION

This summary is provided to comply with 37 C.F.R. § 1.73, requiring a summary of the invention briefly indicating the nature and substance of the invention. It is submitted with the understanding that it will not be used to interpret or limit the scope or meaning of the claims.

There is provided a network security system the employs a method for protecting a computer network from attackers attempting to access or probe its communications ports in preparation for launching an attack. The network security system comprises at least one processor configured to execute computer-executable instructions and a memory for storing the computer-executable instructions. The instructions are configured to implement a security device having one or more triggers, the triggers configured to evaluate incoming data packets addressed to the computer network to determine whether the incoming data packets are suspect data packets or acceptable data packets, wherein the trigger combination that evaluates the incoming packets changes over time.

In certain embodiments, the combination of triggers that evaluates the incoming packets changes over time according to a schedule that is set by a network administrator. In other embodiments, the schedule may vary in a random way. In still other embodiments. The schedule may vary according to a predetermined rotation of triggers.

In certain embodiments, the triggers evaluate the incoming data packets based on one or more of source IP address, destination IP address, destination port, destination protocol, time of day, and rate of attempted connections per unit of time.

In embodiments, upon identification of suspect data packets, the system may log their existence and let the suspect data packets proceed to their destination or port. In certain other embodiments, however, the system may perform one or more protective actions on suspect data packets that have been identified. Some of the protective actions comprise one or more of delaying delivery, blocking access, redirecting to a new destination, and trapping the suspect data packets. In other embodiments, the system may send an alert about the suspect data packets to other related networks. In still other embodiments, the system may present a false response to a request to access a particular port in order to deceive and confuse the attacker.

The system may employ a security device on the perimeter of the network so that all incoming traffic must pass through the system before attempted to navigate the firewall or otherwise access the communication ports. In certain embodiments, a second security device may be located inside the firewall, thereby encapsulating the firewall with security devices.

### BRIEF DESCRIPTION OF THE DRAWINGS

For a fuller understanding of the nature and advantages of the invention, reference should be made to the following detailed description, taken in connection with the accompanying drawings, in which:

FIG. 1 illustrates a prior art firewall protecting a computer network.

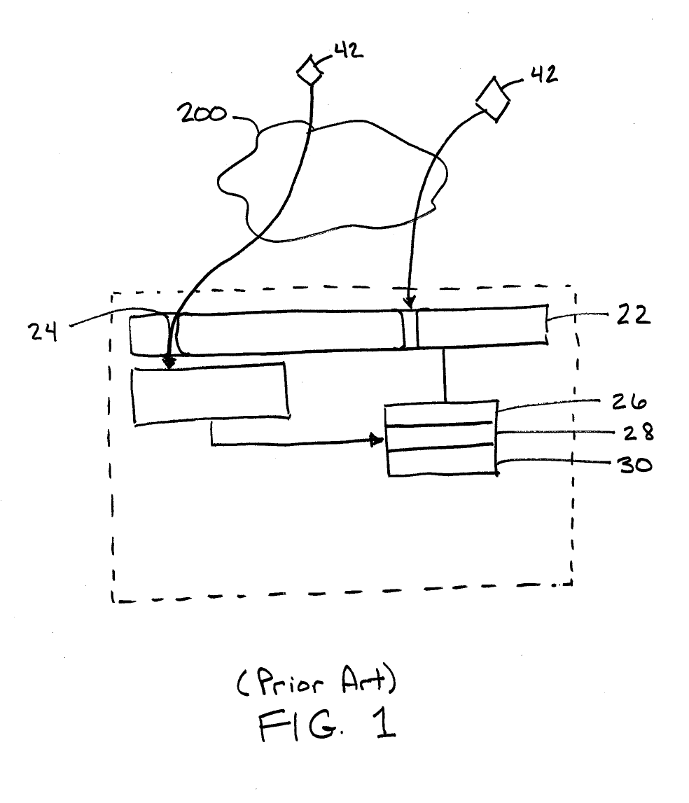

FIG. 2 illustrates a computer system protected by a trigger zone of the present invention.

FIG. 3 is a conceptual representation of a trigger zone implementation.

FIG. 4 is a conceptual representation of a trigger zone implementation.

FIG. 5 is an illustration of an encapsulated enterprise system consistent with an embodiment of the present invention.

### DETAILED DESCRIPTION OF THE INVENTION

The following detailed description includes the best currently contemplated modes of carrying out exemplary embodiments of the invention. The description is not to be taken in a limiting sense, but is made merely for the purpose of illustrating the general principles of the invention, since the scope of the invention is best defined by the claims included herein.

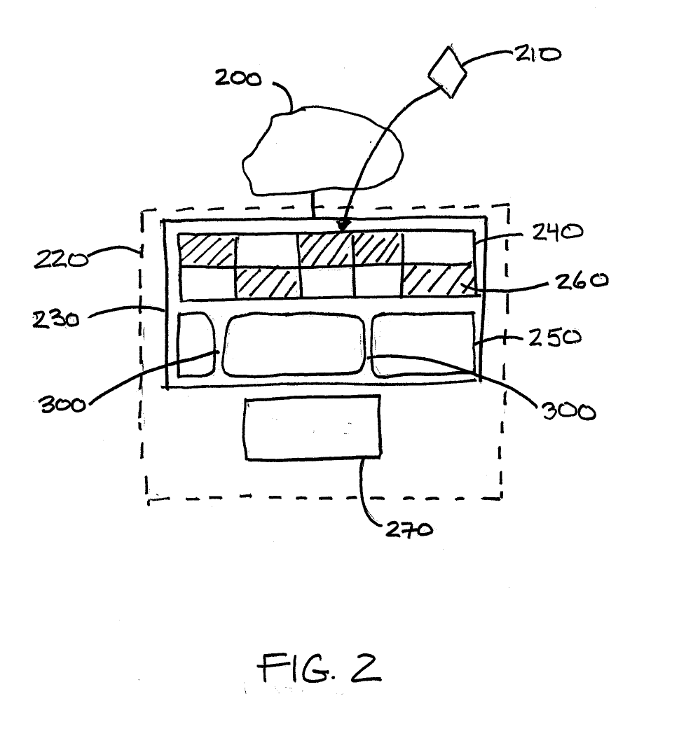

Referring now to FIG. 2, an exemplary embodiment consistent with the present invention is depicted for the protection of a computer system 220 against an attacker 210 attempting to gain access via the internet 200. As the attacker 210 probes the computer system in an attempt to identify active ports 300 available through the firewall 250, it first encounters a trigger zone 240 at an interface with the Internet 200 and then a firewall 250. In embodiments, the trigger zone 240 and the firewall 250 may be housed in a single device 230 or may be housed in separate devices.

Implementations of computer system 220 are described within the context of a system configured to perform various steps, methods, and/or functionality in accordance with aspects of the described subject matter. It is to be appreciated that the computer system can be implemented by one or more computing devices. Implementations of computer system 220 can be described in the context of “computer-executable instructions” that are executed to perform various steps, methods, and/or functionality in accordance with aspects of the described subject matter.

In general, computer system 220, can include one or more processors and storage devices (e.g., memory and disk drives) as well as various input devices, output devices, communication interfaces, and/or other types of devices. Exemplary input devices include, without limitation: a user interface, a keyboard/keypad, a touch screen, a touch pad, a pen, a mouse, a trackball, a remote control, a game controller, a camera, a barcode reader, a microphone or other voice input device, a video input device, a motion sensing device, a gesture detection device, and/or other type of input mechanism and/or device.

A computer system, such as computer system 220, can include a combination of hardware and software. It can be appreciated that various types of computer-readable storage media can be part of a computer system. As used herein, the terms “computer-readable storage media” and “computer-readable storage medium” do not mean and unequivocally exclude a propagated signal, a modulated data signal, a carrier wave, or any other type of transitory computer-readable medium. In various implementations, a computer system can include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

Computer system 220 can implement and utilize one or more program modules. Generally, program modules include routines, programs, objects, components, data structures, etc., that perform particular tasks or implement particular abstract data types.

Computer system 220 can be implemented as a distributed computing system or environment in which components are located on different computing devices that are connected to each other through a network (e.g., wired and/or wireless) and/or other forms of direct and/or indirect connections. In such distributed computing systems or environments, tasks can be performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

As is known, computer system 220 can include servers 270 and workstations, which can be connected by one or more networks. Computer system 220 can be implemented by computing devices such as server computers configured to provide various types of services and/or data stores in accordance with aspects of the described subject matter.

The network or networks that connect various components of computer system 220 can be implemented by any type of network or combination of networks including, without limitation: a wide area network (WAN) such as the Internet, a local area network (LAN), a Peer-to-Peer (P2P) network, a telephone network, a private network, a public network, a packet network, a circuit-switched network, a wired network, and/or a wireless network. The components can communicate via the network or networks using various communication protocols (e.g., Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signaling data types, and/or other data types).

The computer system 220 can include servers 270 that can be implemented by one or more computing devices such as server computers configured to provide various types of services and/or data stores in accordance with aspects of the described subject matter. Exemplary server computers can include, without limitation: web servers, front end servers, application servers, database servers, domain controllers, domain name servers, directory servers, and/or other suitable computers.

The server or servers 270 can include a single central server or, in alternate embodiments, can include one or more servers in communication with each other as appreciated by one skilled in the art. The server or servers can include a repository or database for updates and content information.

Components of computer system 220 can be implemented by software, hardware, firmware or a combination thereof. For example, computer system 220 can include components implemented by computer-executable instructions that are stored on one or more computer-readable storage media and that are executed to perform various steps, methods, and/or functionality in accordance with aspects of the described subject matter.

Computer system 220 can include one or more hardware appliances or virtual appliances. A hardware appliance includes a physical box, such as typical server hardware from Dell, HP, IBM, and other hardware providers, that can be racked and set in secure areas as appreciated by one skilled in the art. Hardware appliances can have software programmed thereon. The user can configure the hardware and his or her router to their desired preferences as discussed below to allow real-time regulation of network traffic, such as blocking or dropping traffic, rerouting traffic, logging traffic, and the like, to occur. In embodiments, hardware appliances can be updated periodically, such as daily, monthly, or annually from a server. A virtual appliance includes, for example, an appliance that can be located on a virtual server such as that provided by VMware® and the like as appreciated by one skilled in the art.

With continued reference to FIG. 2, the computer system 220 configures and implements aspects of certain embodiments of the disclosed invention by configuring and implementing a trigger zone 240. In certain embodiments, the trigger zone 240 comprises a plurality of triggers 260 that can deceive, detect, trap, decoy, alert, log, slow down, allow, and/or block unwanted network traffic when violated. In embodiments, the triggers act as sensors and can be configured to identify the country, company, network IP, protocol, port, time frame, and traffic rate. Additionally, the triggers can be configured to redirect email, send new email, or send text alerts based on certain aspects of the traffic.

In certain embodiments, the trigger zone 240 comprises a computing device that is capable of filtering network traffic. The triggers 260 comprise adjustable traffic sensors that can perform actions based on what they detect and traffic interceptors that can present false responses to attackers' probes, traffic redirectors that are capable of changing traffic destinations.

The computing device housing the trigger zone 240 can be placed in either an active or passive location on the network. In embodiments, the trigger zone 240 can be operated as a passive device wherein it allows traffic to pass and simply logs potential problems and sends alerts to a network administrator. It can also be configured to be an active device wherein it also filters traffic from attackers in real time.

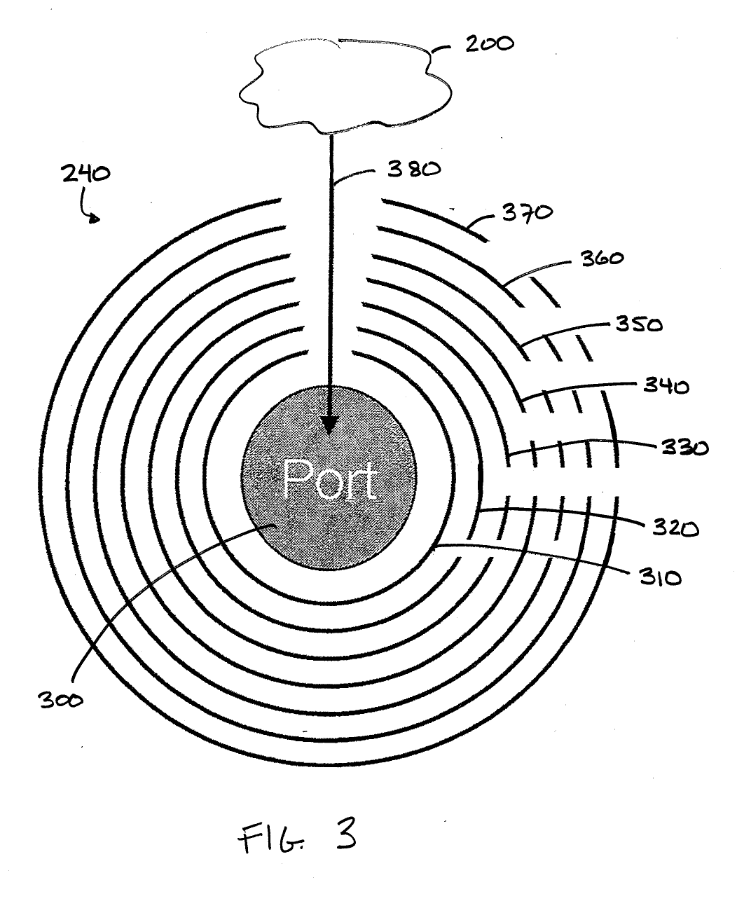

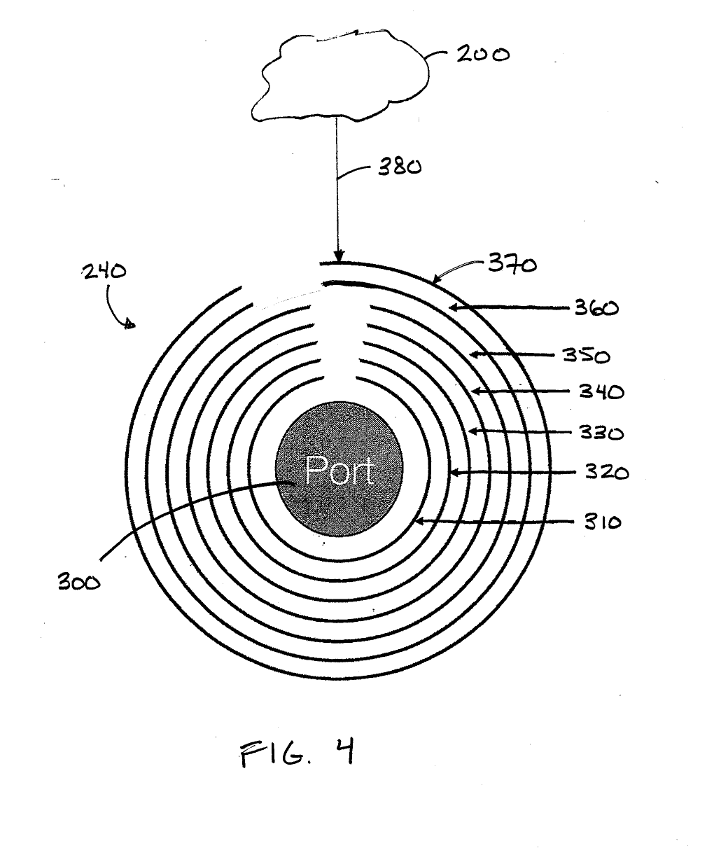

In FIGS. 3 and 4, a conceptual illustration of certain embodiments of the trigger zone 240 placed between the internet 200 and a port 300 or plurality of ports on a network or behind a firewall. The trigger zone 240 contains triggers 310-370 that evaluate packet traffic for evidence of attempted transport layer reconnaissance or attacks. In other embodiments, the trigger zone 240 can evaluate traffic for application or network layer attacks. In accordance with particular embodiments of the invention, the trigger zone 240 is dynamic in the sense that it is constantly modulating the types of triggers it uses over time in order to keep attackers off balance. This modulation of trigger types can also change on a schedule.

In certain embodiments, the trigger zone 240 can be configured to operate in a dynamic mode wherein the triggers 260 that are applied to packet traffic rotate in and out of use and can be alternatively passive or active. In certain embodiments, the triggers can evaluate each packet based on one or more of Source or Destination IP address 310, Source or Destination Network IP address 320, Source Company IP Address 330, Source Country 340, Destination Port or Protocol 350, Time of Day 360, and Rate of connections or attempted connections per unit of time 370. Those of skill in the art will recognize that other triggers may be possible.

In FIG. 3, a packet 380 encounters no triggers and is allowed to proceed to a network port 300 or firewall unencumbered because none of the triggers 260 are scheduled to be active. In FIG. 4, a packet 380 encounters a rate trigger 370 that monitors attempts to contact the port 300 and denies access where those attempts exceed a predetermined rate. In certain embodiments, the predetermined rate might be one hundred connection attempts in fifteen seconds, but those of skill will recognize that other limitations are appropriate in certain circumstances and a graphical user interface, such as a dashboard presented on a monitor as is known in the art, will enable a network administrator to adjust the rate to a preferred amount. If network traffic does not violate this trigger, access to the port 300 would be permitted.

The system in FIG. 4 also has a time trigger 360 that is active. By way of example, the time trigger 360 may indicate that any other active triggers will evaluate incoming traffic according to the rules of that trigger between 1 pm and 5 pm on weekdays. If the rate trigger 370 is monitoring for traffic greater than 100 connection attempts in 15 seconds, for example, if it was Tuesday at 2:30 pm, the time trigger 360 would allow the rate trigger to be active and perform the action specified for all such traffic over that rate. At 5:30 pm that same day, however, the rate trigger would not be active.

To make the trigger zone 240 dynamic and keep attackers off balance, a scheduling routine can be used to enable a network administrator to have different triggers turned on and off automatically by varying the time trigger 360. Enabling and disabling triggers at different times changes the network perimeter dynamically and makes the experience of would-be attackers different each time they try to scan for vulnerabilities. Using the scheduler, a network administrator can schedule any combination of triggers to be active at any combination of times and dates.

Computer system 220 can configure and implement the firewall 250 and the trigger zone 240 on the same server or on separate servers 270. In embodiments, the trigger zone 240 can be located just outside the firewall 250 so that traffic from the internet 200 must pass through the trigger zone 240 before it hits the firewall 250, all within a security component 230. Alternatively, computer system 220 can configure and implement the trigger zone 240 on a separate security device, such as a router, another firewall, or other similar device. In certain embodiments, a trigger zone 240 can be placed behind a firewall 250 either in addition to a trigger zone 240 outside the firewall, called encapsulation, or by itself. The location of the security device housing the trigger zone 240 on a network is a matter of judgment on behalf of the network administrator and depends on the goals of the security strategy for that particular network.

It should also be understood that, in certain embodiments, the servers 270 can include a protected website for performing human resources functions, banking functions, investment functions, school portals, medical provider portals, sensitive federal repositories or other functions involving similarly sensitive information. In such instances, the port 300 is a web portal.

In other exemplary embodiments, the port 300 can function as an administrative web portal to provide access to web servers, mail servers, databases, or cloud services management residing on the servers 270. Alternatively, the port 300 can provide remote access when the servers 270 include a remote desktop communication to VMView, Citrix, and/or Secure Shell Access portals. Additionally, the port 300 can provide access to file transfers, FTP, secure file transfer protocol (SFTP) servers or similar protocols or functions that are implemented by the servers 270.

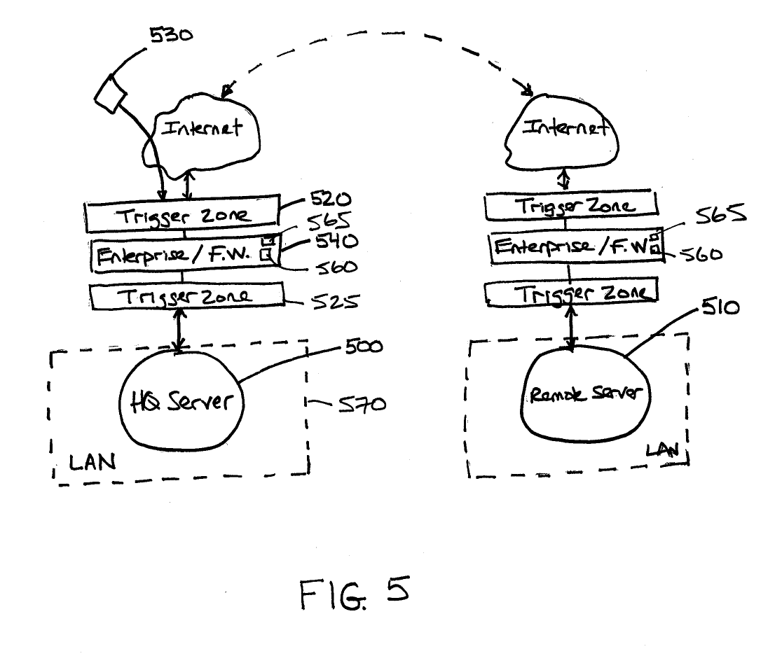

In certain embodiments, the present invention can also be deployed across a wide area network having multiple access points to the internet. In FIG. 5, a HQ computer server 500 is in communicative operation with a remote server 510. In the event that the HQ external trigger zone 520 identifies a threat 530 to the network, the enterprise control module 540 immediately communicates the threat 530 to remote server 510 so that all systems within the same enterprise are protected. Information such as the attacker's source IP address, for example, can be used to protect the enterprise from the attack.

In certain embodiments, the enterprise control module may contain deception taps 560, which are ports to which a network cable can be connected in order to be configured with triggers, sensors, redirectors or other interception means. Decoy sensors 565 may also be employed as false network services that are used to trick attacker probes to get them to reveal information about themselves, which is then communicated via email, SMS or log to the other protected systems through an automated sync, by way of example. Further, these decoy sensors 565 may automatically block, slow down, or quarantine packets from an attacker. Other triggers have already been described and can be employed in an enterprise situation just as easily as if they were protecting a standalone network.

FIG. 5 also illustrates an encapsulation installation of trigger zones. The HQ external trigger zone 520 is coupled with an HQ internal trigger zone 525 to better protect the network 570. In certain embodiments, the external trigger zone 520 contains deception tactics for post-NAT traffic; whereas the internal trigger zone 525 contains deception tactics for pre-NAT traffic.

The invention has been described with respect to a number of embodiments and explained with reference to preferred arrangements, possible alternatives and other examples; however, the invention is not limited to the embodiments given as examples.

I claim:

1. A computer-implemented method for providing security to a protected computer network having communication ports, the computer-implemented method comprising:
receiving, on a network security device, incoming data packets that are addressed to the protected computer network;
evaluating the incoming data packets with one or more triggers to determine whether the incoming data packets are suspect data packets or acceptable data packets;
changing the one or more triggers that evaluate the incoming data packets over time according to a schedule; and
performing one or more protective actions on the suspect data packets; and
allowing the acceptable data packets to access the communication ports.

2. The method of claim 1, wherein the step of evaluating incoming data packets occurs before the data packets encounter either a firewall or the communication ports.

3. The method of claim 1, wherein the step of evaluating incoming data packets occurs after the data packets encounter either a firewall or the communication ports.

4. The method of claim 1, wherein the step of evaluating incoming data packets occurs both before and after the data packets encounter either a firewall or the communication ports.

5. The method of claim 1, wherein the one or more triggers evaluate the incoming data packets based on one or more of source IP address, destination IP address, destination port, destination protocol, time of day, and rate of attempted connections per unit of time.

6. The method of claim 1, wherein the protective actions comprise one or more of logging, allowing, delaying, blocking, redirecting, and trapping the suspect data packets.

7. The method of claim 6, wherein the protective actions further comprise sending an alert about the suspect data packets to other networks having communications ports.

8. The method of claim 6, wherein the protective actions further comprise presenting false responses to requests for access to one or more ports to deceive and confuse attackers.

9. The method of claim 1, wherein the schedule comprises times when each trigger is actively evaluating incoming data packets.

10. A network security system for protecting a computer network having communication ports from attackers attempting to access those ports, the network security system comprising:
at least one processor configured to execute computer-executable instructions and memory storing computer-executable instructions, the instructions configured to implement:
a security device having one or more triggers configured to evaluate incoming data packets addressed to the computer network to determine whether the incoming data packets are suspect data packets or acceptable data packets, wherein the triggers are changeable over time.

11. The network security system of claim 10, wherein the one or more triggers evaluate the incoming data packets based on one or more of source IP address, destination IP address, destination port, destination protocol, time of day, and rate of attempted connections per unit of time.

12. The network security system of claim 10, wherein the security device is further configured to perform one or more protective actions on the suspect data packets.

13. The network security system of claim 12, wherein the one or more protective actions comprise one or more of logging, allowing, delaying, blocking, redirecting, and trapping the suspect data packets.

14. The network security system of claim 12, wherein the protective actions further comprise sending an alert about the suspect data packets to other networks having communications ports.

15. The network security system of claim 12, wherein the protective actions further comprise presenting false responses to requests for access to one or more ports to deceive and confuse attackers.

16. The network security system of claim 10, wherein the triggers that evaluate incoming data packets change according to a schedule, whereby attackers encounter a different security challenge each time they try to attack.

17. The network security system of claim 16, wherein the schedule is based on a twenty-four hour period set by a user.

18. The network security system of claim 10, wherein the security device is located behind a firewall whereby only incoming data packets that pass the firewall are evaluated.

19. The network security system of claim 10, wherein security devices are placed both in front of and behind a firewall.

20. The network security system of claim 10, wherein the acceptable data packets are passed through to one or more of the communications ports and a firewall.
